(19) United States
(12) Patent Application Publication
(10) Pub. No.: US 2021/0163745 A1
(43) Pub. Date: Jun. 3, 2021

(54) MELT FLOWABLE BIOCARBON AND METHOD OF MAKING SAME

(71) Applicant: Attis IP, LLC, Milton, GA (US)

(72) Inventors: Michael J RIEBEL, Mankato, MN (US); Milton J RIEBEL, Mankato, MN (US)

(21) Appl. No.: 16/994,159

(22) Filed: Aug. 14, 2020

Related U.S. Application Data
(60) Provisional application No. 62/889,367, filed on Aug. 20, 2019.

(51) Int. Cl. C08L 97/00; C08K 11/00; B29B 9/16; B29B 9/12; C09C 1/60

(52) U.S. Cl. CPC C08L 97/005; C08K 11/005; C08L 2201/06; B29B 9/12; C09C 1/60; B29B 9/16

(57) ABSTRACT

The following invention generally relates to a melt flowable biocarbon polymeric material derived from a cellulosic ethanol refining co-product, monolignol biopolymer, and a heat processed or thermally modified biomass flour, both of which are reacted together to create a melt flowable biopolymer which has melt flowable properties, process-ability and rheology similar to that of standard petrochemical based thermoplastics.

### CROSS REFERENCE TO RELATED APPLICATION

This application claims the full benefit and priority of pending provisional application No. 62/889,367, filed Aug. 20, 2019, entitled “MELT FLOW ABLE BIOCARBON AND METHOD OF MAKING SAME”. The entire contents of this application is incorporated herein by reference.

### COPYRIGHT STATEMENT

A portion of the disclosure of this document contains material subject to copyright protection. No objection is made to facsimile reproduction of the patent document or this disclosure as it appears in the Patent and Trademark Office files or records, but otherwise any and all rights, including copyrights), are reserved.

### FIELD

This disclosure relates to a melt flowable biocarbon and methods for making and using same

### INTRODUCTION

This section provides some introduction to various matters relating to the invention mentioned herein but it should be understood that this should not be construed as prior art to the invention; certain materials may be included, referenced, or alluded to in this section that may be inventions of the inventors noted herein. This section is simply included to include some introduction for the sake of the reader, some of which may be background to the invention, and some which is not.

With the growing demand for petrochemical thermoplastics and their environmental concerns, various bioplastics and biobased fillers have been growing in market acceptance. Additional environmental pressures are also being placed on the usage of PVC plastic which has various environmental and health problems being considered the “poison plastic”. We also see a growing demand for wood plastic composite wherein commodity thermoplastics are blended with various wood or biobased fillers to create decking, windows and products for lumber replacements Although these have some good properties and better for water resistance than real wood, they still do not have sufficient water resistance, thermal stability, potential to mold, required additional expensive antioxidants and other problematic characteristics.

Various bio fillers include ground wood, sawdust, agricultural fiber, starch, proteins, kraft lignin and other biobased natural material. These are typically blended with petrochemical thermoplastics such as PVC and HDPE. This is commonly used for wood plastic lumber including windows, decking and other composite applications to replace lumber. Virtually all fillers currently used in such composites absorb water and also can mold, swell and degrade. Given the incompatibility of polar fillers and non polar plastics, the plastic simple attempts to encase the fillers if cut the fillers are exposed to the elements and problems are created. These fillers also have issues with compatibility, brittleness, melt viscosity modification and most of all non polar thermoplastics and polar wood is difficult to couple to create truly water proof composites. They all are basically water absorbing inert fillers and do not melt nor flow. Moreso, the petrochemical thermoplastic with various bio fillers are not very thermally stable, UV stable, and difficult to process in additions to other limitations

These materials do not provide for a true melt flow to emulate a plastic, but only provide reinforcement within a plastic composite. In addition the bio filler is simply encapsulated within the plastic material and no thermoplastic substantially impregnates into the biobased or wood fillers. Fillers are typically limited to 1% to 30% given higher of filler levels can create brittleness in plastics and adversely effect the plastic flow rates. Wood plastic lumber can load at levels around 50%, but start to loose their moisture resistance and are prone to mold and swelling. It is known in the art of various synthetic, mineral or biobased fillers for plastics all which provide reinforcement to various degrees, but are limited in amounts that can be used given it can create brittleness or lack of impact resistance in plastics,

Various bio fillers for thermoplastic are well known comprising various biobased fillers such as wood flour which is the basis for wood plastic composites. Other prior art teaches of blending starches or proteins with various plastics. Their is various art using biobased or agriculturally derived fillers which typically are added to plastics at level between 10% to 50%, but all do not flow, create higher viscosities and reduce impact resistance.

More recently various biobased materials such as wood or ethanol by products have been pyrolyzed at high temperatures for plastic filling applications as an inert fillers. US Patent Pending 20170253805 Cernohous teaches of a method comprising pyrolyzes biobased feedstock from ethanol by products which are then melt mixed with various plastics. In this art, the black charcoal like material is a filler in plastics similar to that of a mineral filler and has no flow properties. This art actually increases the viscosity of the thermoplastic to a point wherein the mix is difficult to flow. Although this does improve water resistance, it still relies on petrochemical thermoplastic which are thermally unstable,

Various tillers in plastics have also included precipitated lignin. Although lignin is considered a natural polymer, it is not meltable. Kraft lignin is the most common form of lignin in prior art which is acid precipitated from black liquor. The acid treatment thermosets the material so that it is not a meltable material, thus no more than an inert filler.

Monolignol Biopolymers

Various new art and patents teaches of a hybrid organosolv/reactive phase separation process which takes biomass from trees or agricultural biomass and is reacted with self generated chemicals produced within the organosolv process. The lignin then reacts with the self generated biochemicals and also goes through ring opening polymerization. The resulting material is a black shinny polymeric material called meltable lignin extract. Meltable Lignin Extract has low viscosity and melts at a very low temperature typically less than 100 C which is impractical for most ail plastic applications.

Organosolv Lignin extracts are produced using the process as that described in U.S. Pat. No. 9,365,525 (System and method for extraction of chemicals from lignocellulosic materials) herein incorporated by reference in its entirety.

Published US Patent publication number 2019/0062508 to WISNESS et al, published 2019 Feb. 28 (Winsness/Riebel), incorporated by reference, teaches of modifications to the hybrid organosolv/phase separation process and addition of functionalized materials where various additional materials and polymers can be added and reacted within the process as to create a truly thermoplastic behavior melt flowable lignin biopolymer that melts at a specific temperature range herein incorporated by reference in its entirety.

This patent generally relates to the field of a melt flowable lignin material derived from various biomass sources using a hybrid organosolv/reactive phase separation/purification process. Within this art biomass is separated during this reaction and biochemicals are self generated which further reacts with the lignin to create a unique melt flowable lignin. These lignin based biopolymers have a low viscosity, high melt flow index, higher aliphatic OH groups, and many other advantages Its disadvantage is that the material can be sticky during extrusion, low melting point, limited compatibility with various thermoplastics and a significant odor.

The present invention further improves on this cellulosic organosolv extract by means of reaction and devolatilization prior to further reactions when coupling the heat modified biomass powder. This invention including various heat modified biomass powders or finely divided materials. Heat modification processes can range from highly dried wood flour, thermally modified wood flour, torrefaction wood, or biochar that is pyrolyzed biomass. The present invention also requires a fine grind into a “flour like” consistency.

Biochar has been developed primarily for bio Coal or biobased fuel pellet applications, soil amendment and more recently as a filler in plastics. Biochar is produced wherein various biomass including but not limited to wood, agricultural fiber, nut shells, grasses and other forms of biomass are subjected to high heat in an reduced oxygen environment to “carbonize” the material.

Recently US patent pending, 20170107334 N4ohanty teaches of integrating biomass that has been pyrolyzed into charcoal which is then used as a filler or replacement for carbon black fillers in thermoplastics. Although this is a positive step forward in this solution, charcoal does not melt flow and greatly increases the melt viscosity of plastics in processing to the point where limited percentage can be practically used. This also is basically an inert filler which limits the levels it can be added with various plastics.

There is a demand in the global market for biobased materials and more so biobased plastics that are price competitive with petrochemical products. Currently most all biobased materials or plastics are simply more expensive than petrochemical plastics which has greatly limited their acceptance. Secondly, as cellulosic biofuels and other biorefinery project continue to be explored, developed and constructed it is critically important to find additional value added applications and markets for economic viability,

U.S. Provisional Patent by University of Minnesota Duluth NRRI teaches of integrating a forms of organosolv extract with course wood or course torrefaction processed wood to create a higher energy pellet in which the melt flowable organosolv extract is used as a simple binder for energy pellet production. This does not react or fully impregnate the biomass and uses simple pelleting processes. Lignin extraction processes useful in the method of this disclosure are described in the following patents: U.S. Pat. Nos. 8,465,559, 8,211,189, and 9,365,525. More specifically this does not require a key devolatilization process that is important within this patent application that polymerizes the monolignol biopolymer. More so this patent uses a melt flowable lignin extract as a low percentage binder to burn as an energy pellet and the resulting blends are not melt flowable at addition levels claimed within this patent application. In addition, this requires a large particle of wood or torrefaction processed wood for burning. This does not provide for sufficient melt flow or coupling reactions sufficient for a melt flowable biocarbon material.

In addition there is a. strong need and demand to replace PVC given its various health and environmental problems with a “green solution” that is renewable, biobased and meets PVC performance.

The invention within provides for a solution for the above limitations by providing new forms of biopolymers, biocomposites and bioplastic solutions that have higher strength, improved thermal stability, matching melt flow viscosity, antimicrobial/antioxidant properties and most of all can be produced and sold at a lower cost than petrochemical plastics.

### SUMMARY OF THE INVENTION

The following invention generally relates to a melt flowable biocarbon polymeric material derived from a cellulosic ethanol refining co-product, monolignol biopolymer, and a heat processed or thermally modified biomass flour, both of which are reacted together to create a melt flowable biopolymer which has melt flowable properties, process-ability and rheology similar to that of standard petrochemical based thermoplastics.

Therefore, it is an object of the present invention to provide a melt flowable biocarbon polymer comprising a blend of a melt flowable monolignol biopolymer and a thermally processed biomass flour.

It is a further object of the present invention to provide a melt flowable biocarbon as noted above wherein the melt flowable monolignol biopolymer is derived from a hybrid organosolv/reactive phase separation cellulosic biofuel process by further devolatilizing and reacting a meltable lignin extract.

It is a further object of the present invention to provide a melt flowable biocarbon as noted above wherein the thermally processed biomass is derived from trees, wood, wood waste, agricultural residues, nut or seed hulls or blends thereof.

It is a further object of the present invention to provide a melt flowable biocarbon as noted above wherein thermal processed biomass can be dried wood flour, thermally modified wood flour, torrefied wood flour, pyrolyzed wood flour, biochar or blends thereof.

It is a further object of the present invention to provide a melt flowable biocarbon as noted above wherein thermally processed biomass flour has a mesh size between 30 to 500 mesh.

It is a further object of the present invention to provide a melt flowable biocarbon as noted above thermally modified biomass flour comprises 1-60% of the melt flowable biocarbon.

It is a further object of the present invention to provide a. melt flowable biocarbon as noted above the melt flowable biocarbon has a melt flow similar to thermoplastics, antioxidant and antimicrobial functionality and highly hydrophobic..

It is a further object of the present invention to provide a melt flowable biocarbon as noted above the thermally processed biomass flour is substantially fully impregnated by the monolignol biopolymer.

It is a further object of the present invention to provide a melt flowable biocarbon as noted above the melt flowable biocarbon comprising a heat reacted blend of monolignol biopolymer and thermally processed biomass in the form of a powder, granular, pellet, shaped extrusion, injection molded shape, compression molded shape or sheet.

It is a further object of the present invention to provide a melt flowable biocarbon as noted above it further comprises a thermoplastic, bioplastics or thermoset polymer.

It is a further object of the present invention to provide a melt flowable biocarbon as noted above the thermoplastic is selected from polyethylene (PE), crosslinked-polyethylene (PEX), polypropylene (PP), impact polypropylene, and polybutylene (PB), polyvinylchlofide (PVC), chlorinated polyvinyl chloride (CPVC), polyvinylidene fluoride (PVDF), polystyrene (PS), acrylic polymers, nylon, acrylonitrile butadiene styrene, thermoplastic polyurethanes, polycarbonates, ABS, Metalocene, EVA or combinations thereof.

It is a further object of the present invention to provide a melt flowable biocarbon as noted above the bioplastics is selected from polylactic acid) (PLA), poly glycolic acid (PGA), poly(lactic acid-co-glycolic acid (PLGA), polycaprolactone, polyhydroxyalkanoates, PBAT or combinations thereof.

It is a further object of the present invention to provide a melt flowable biocarbon as noted above further comprising a functional additive: polyol, plasticizer, oil, wax, lubricant, colorant, mineral, epoxified oil, isocyanate, polyester resin, acid couplers, etc.

It is a further object of the present invention to provide a melt flowable biocarbon as noted above wherein the addition level of thermally processed biomass ranges from 0.5% to 60%.

It is a further object of the present invention to provide a melt flowable biocarbon as noted above wherein the carbon content is greater than 50%.

These and other aspects will become readily apparent upon further review of the following specification and drawings. Other objects, features, and advantages of the present invention will become apparent upon reading the following detailed description of the preferred embodiment of the invention when taken in conjunction with the drawing and the appended claims.

### BRIEF DESCRIPTION OF THE DRAWINGS

FIG. 1 shows a basic inventive concept according to one embodiment of the present invention.

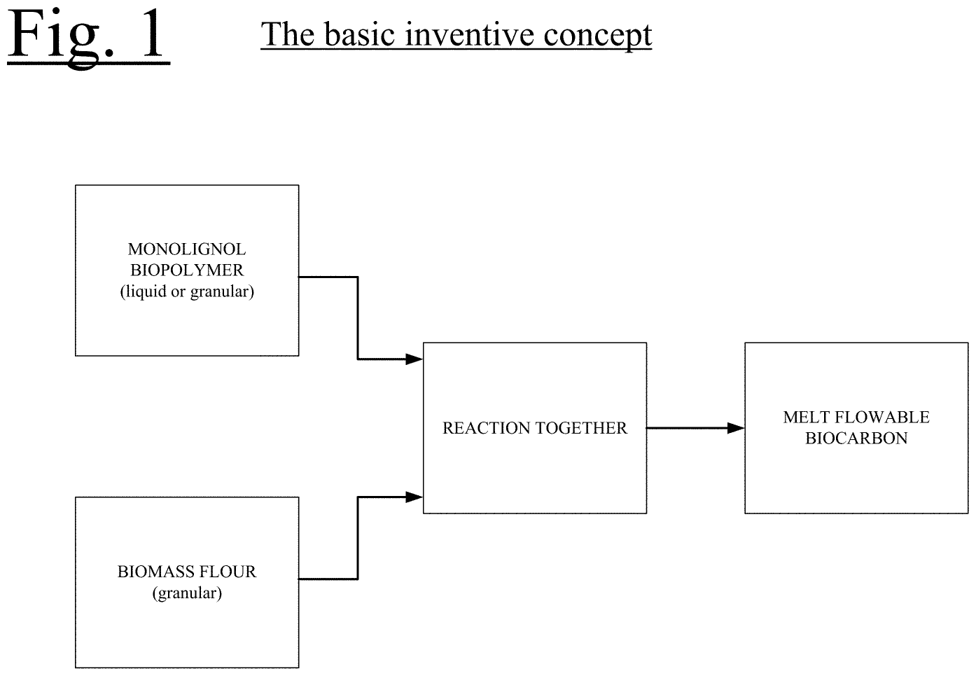

FIG. 2 shows the provision and use of a granular monolignol biopolymer.

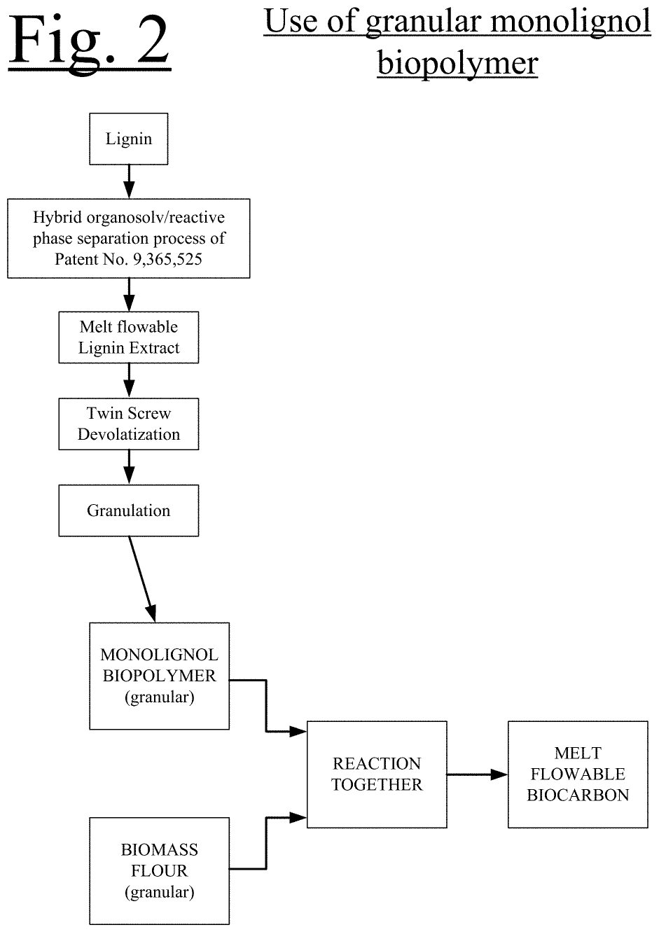

FIG. 3 shows the provision and use of a liquid lignin extract.

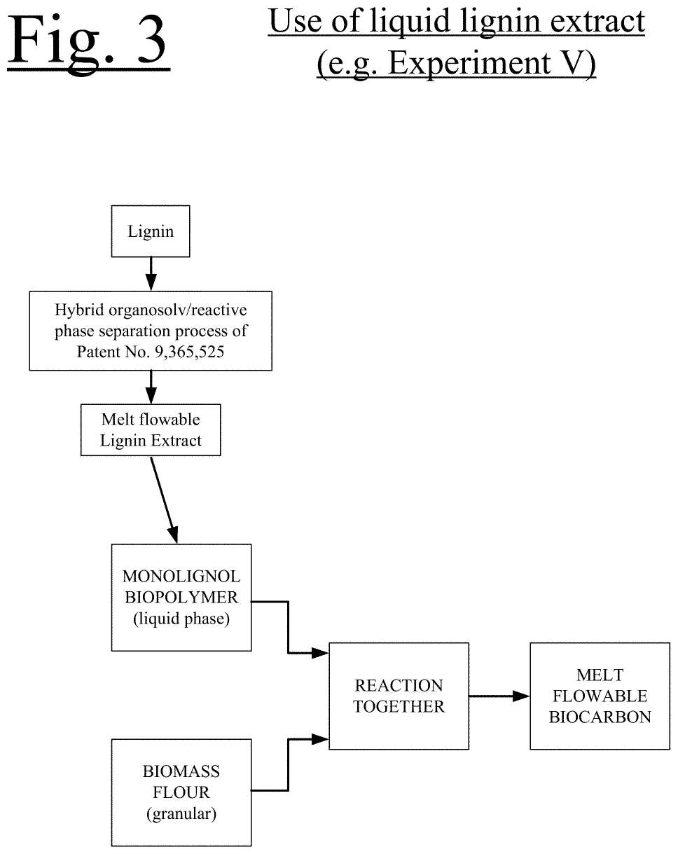

FIG. 4 shows various types of biomass flour used,

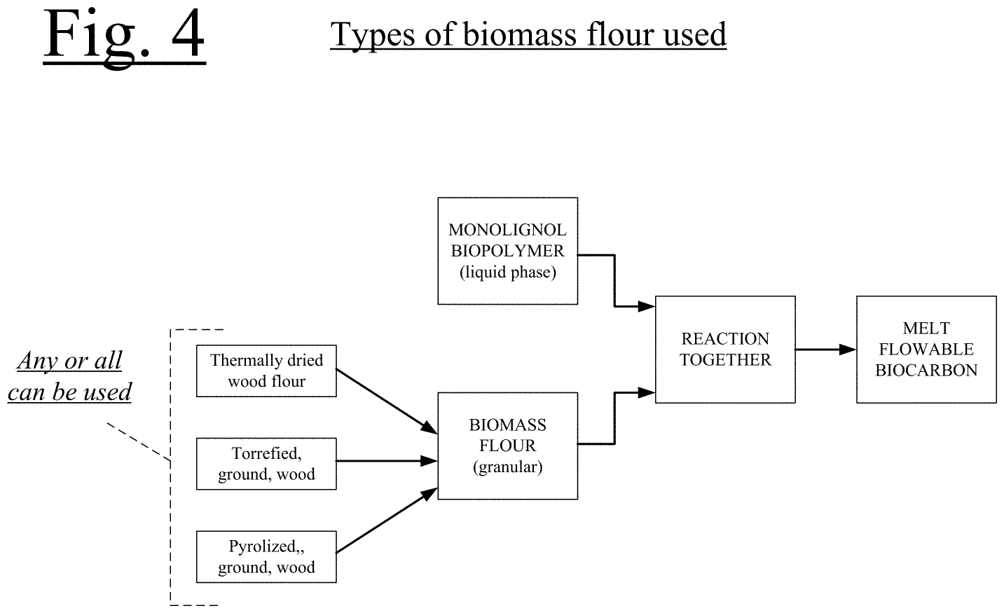

FIG. 5 shows the reaction process and options.

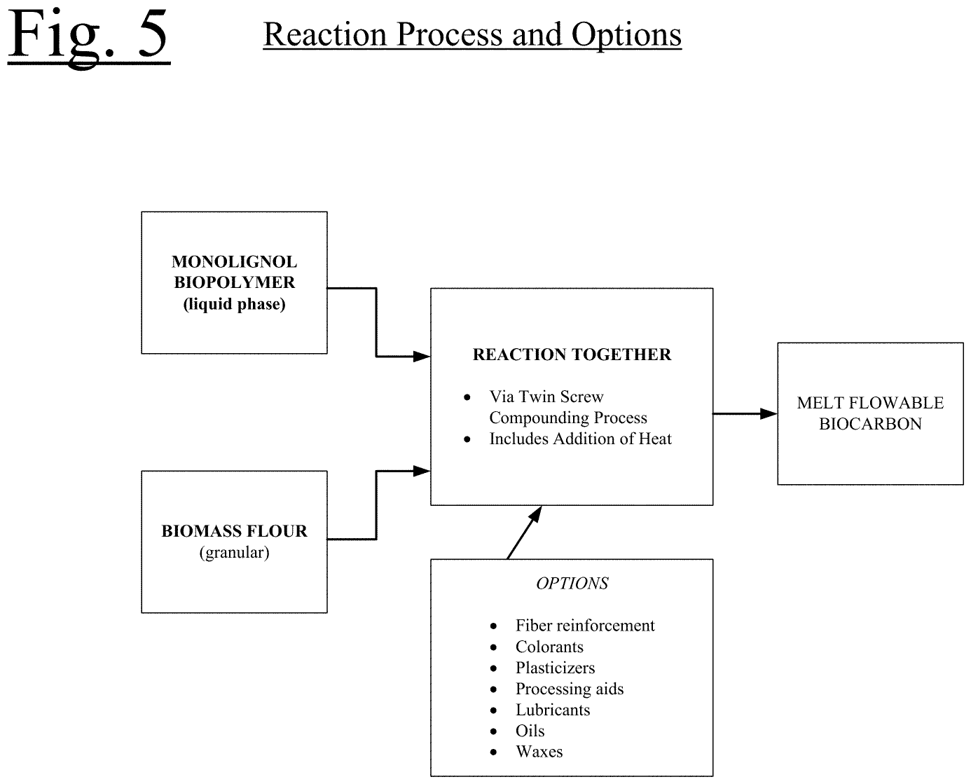

FIG. 6 shows post mixing processes.

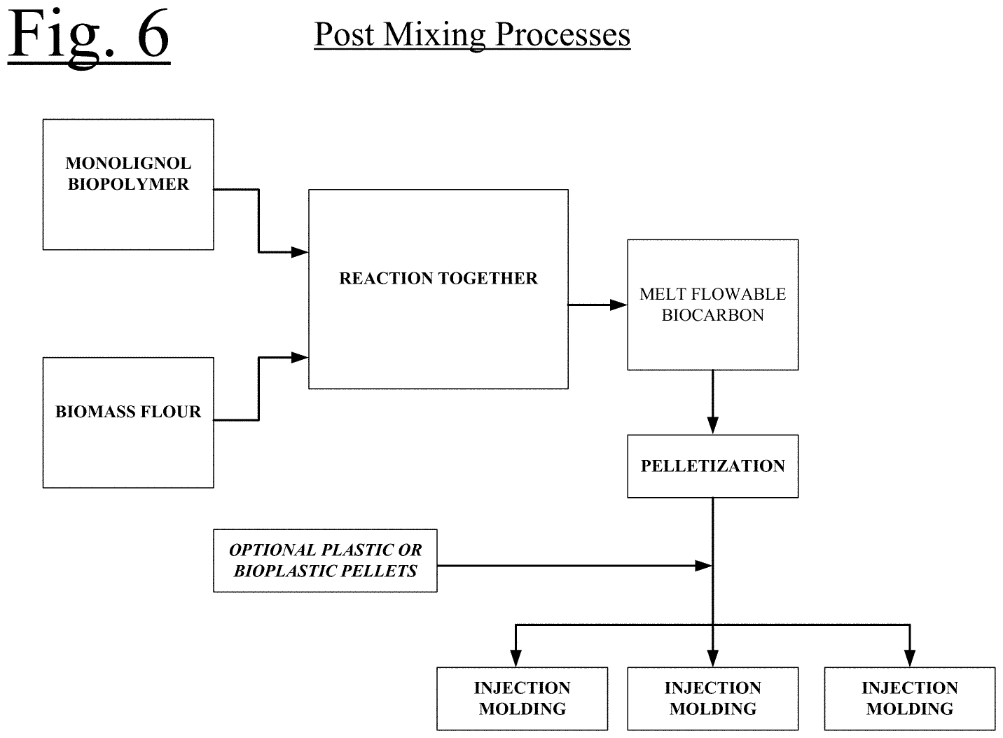

FIG. 7 shows a melt flowable biocarbon process, under the concept of FIG. 2.

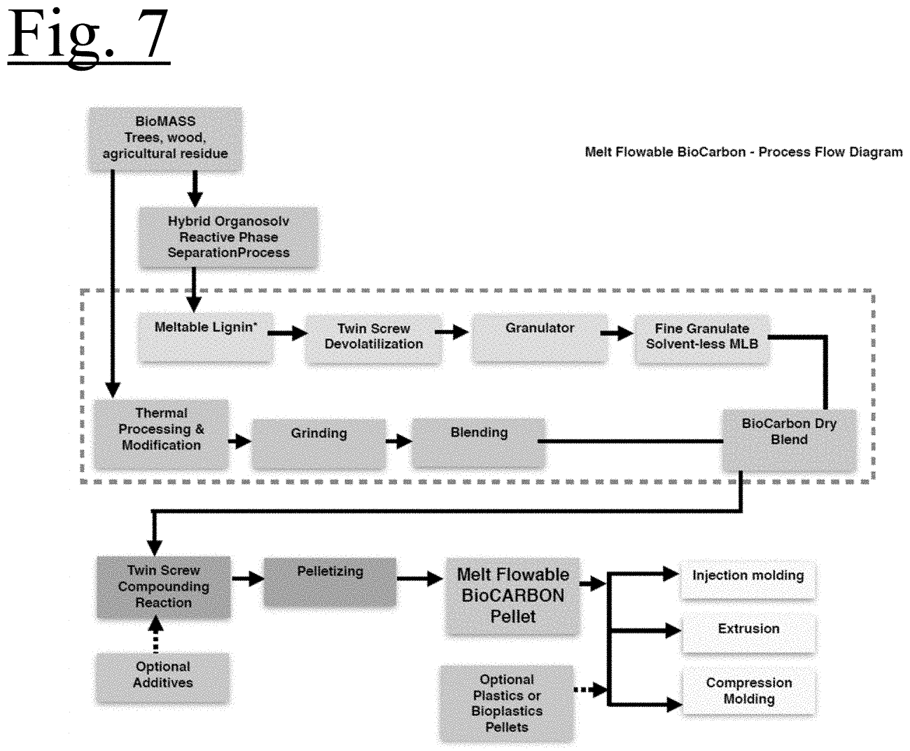

### DETAILED DESCRIPTION OF THE INVENTION

Definitions

Melt flowable lignin extract as used herein is based on meltable lignin such as, for a non-limiting example, that as described in U.S. Pat. No. 9,365,525 (System and method for extraction of chemicals from lignocellulosic materials) and U.S. Pat. No. 9,382,283 (Oxygen assisted organosolv process, system and method for delignification of lignocellulosic materials and lignin recovery) herein incorporated by reference in its entirety. Meltable lignin extract that is produced using a hybrid organosolv/reactive phase separation process that reacts lignin with self generated biochemicals within the hybrid organosolv process and reacted within the phase separation process to first create the meltable lignin material.

Monolignol biopolymer is used herein by further high heat processing of the melt flowable lignin extract by means of vented twin screw extrusion in which the material is further reacted and devolatilized to provide a higher melting point and appropriate viscosity typically to thermoplastic processing. A high carbon Melt flowable lignin based biopolymers can be created using processes within Winsness/ Riebel Pending Patent, herein incorporated by reference in its entirety.

Thermally processed biomass flour as used herein is based on tine grinds of various biomass including, but not limited to trees, wood, bark, agricultural residues, seed hulls, food processing byproducts or blends thereof which are subjected to heat and ground into a tine flour, powder or granular between 30 mesh to 500 mesh.

Thermally modified biomass flour as used therein is based on fine grinds of various biomass in which the thermal modification is done by drying and/or under a reduced oxygen atmosphere as in torrefaction and pyrolysis processes.

“biobased elemental carbon” or “elemental carbon”, or “Biocarbon” as used herein, refers to the material obtained from heating ground wood biomass (for example, by chopping or grinding) biomass, such as plant fibers, agricultural/forest biomass, municipal solid waste (MSW), and/or animal/bird manures, etc. The heating can be done at a wide range which simply dries wood flour, torrefaction or pyrolysis to create a fine powder or flour carbon rich biomass. The pyrolysis and torrefaction is typically performed at about 400° C. and up to about 900° C. in low oxygen wherein standard heat process also can be used to remove the moisture within the biomass.

For purposes of this application, the term “biochar” shall be given its broadest possible meaning and shall include any solid carbonaceous materials obtained from the pyrolysis, torrefaction, gasification or any other thermal and/or chemical conversion of a biomass. Pyrolysis is generally defined as a thermochemical decomposition of organic material at elevated temperatures in the absence of, or with reduced levels of oxygen. When the biochar is referred to as “treated” or undergoes “treatment,” it shall mean raw, pyrolyzed biochar that has undergone additional physical, biological, and/or chemical processing.

“Thermoplastic”, as used herein, refers to a material, such as a polymer, which softens (e,g., becomes moldable or pliable) when heated and hardens when cooled.

“Bio-plastic” as used herein, refers to materials that are essentially derived from biomass and/or biobased.

“Carrier resin” refers to plastics used for the production of the master batch. They present important properties such as the melt flow and molecular weight that impact directly in the processing of the master batch.

“Melt flow index” or “MFI”, as used herein, refers to the measure of the ease of flow of the melt of a thermoplastic polymer or composite. It is defined as the mass of polymer or composite, in grams, flowing in ten minutes through a capillary of a specific diameter and length by a pressure applied via prescribed alternative gravimetric weights for alternative prescribed temperatures. The method is described in the similar standards ASTM DI 238 and ISO 1133.

Section 1

Raw biomass is a potential source of renewable carbon-based polymer, plastics and composites as a lower cost replacement for petrochemical derived plastics, polymers, and composites.

Under one aspect of the present invention, melt flowable biocarbon comprises a reacted blend of monolignol biopolymer that is derived from cellulosic ethanol production and very finely divided heat modified biomass. Both the monolignol biopolymer and heated finely ground biomass have a high biocarbon content, are both melt flowable together, and both have unique properties such as improved thermal stability, high strength, antioxidant and antimicrobial properties.

The monolignol biopolymer is melt reacted with the heat modified biomass using twin screw compounding systems or other means to blend, heat, couple and impregnate the powdered heat modified biomass within the monolignol biopolymer. The biomass powder material, typically in the form of wood or agricultural residue, is heated and ground yielding very finely divided particles or flour like consistency. Finely divided heated biomass flour can be in the form of dried wood flour, thermally modified wood flour, dried agricultural residue flours such as straw, stalks, seed hulls, torrefaction processed biomass, or pyrolysis (biochar) processed biomass.

Under one aspect of the present invention, the monolignol biopolymer and heat treated/ground biomass is reacted, coupled and impregnated to form a melt flowable biocarbon rich polymeric material. The melt flowable biocarbon can be used by itself in various plastics or composites applications or be blended with various thermoplastics, bioplastics, biochemicals and polymers additives to lower cost, improved performance, provide antioxidant/antimicrobial functionality, provide higher strengths, provide higher thermal stability, provide higher aliphatic OH reactivity and provide a green solution for petrochemical plastics.

Another object of this invention is formulations and methods using melt flowable biocarbon with an plastic, impact modifies, plasticizers or other additives to create anew hybrid environmentally friendly alternative to PVC and other petrochemical based plastic or composite products for both interior or exterior applications.

Section 2

Said another way, the following invention is based on a reacted blend of monolignol biopolymer derived from a specific cellulosic ethanol process using hybrid organosols and phase separation reactions in which lignin is subjected to reaction with “self generated” biochemicals such as butyl acetate, furfural derivatives, acetic acid and other self generated biochemicals within this process. The monolignol biopolymer is then created by further reacted by devolatilization using a vented extrusion system. Monolignol biopolymers typically have a high elemental carbon percentage typically over 70%. In addition monolignol biopolymers have higher aliphatic OH group values, highly polar, highly hydrophobic properties, high antioxidant and antimicrobial functionality and high UV inhibiting properties. The monolignol biopolymer is then heat reacted and compounded with various forms of high carbon powdered biomass.

High carbon biomass can include, but not limited to, various forms of finely divided biomass from wood or agricultural residue sources. Finely divided can mean a particle sizes from 30 mesh to greater than 200 mesh, Various terms such as flour is commonly used. The biomass flour is also subjected to thermal modification. Wood flour is subjected to heat sufficient for drying and removal of some volatile components. Torrefaction typically heats wood in a low oxygen environment to remove even more volatile components. BioChar or wood processed using pyrolysis removes even further volatile components and yields the highest level of elemental carbon. All thermally modified biomass is ground into a fine flour either prior to thermal treatment or post thermal treatment in a mesh size range from 20 to 300, and more preferable between 50-300 and most preferably between 100-250.

Both the monolignol biopolymer, having carbon contents of approximately 75% and various forms of thermally processed or thermally modified biomass can have carbon contents ranging from 50% to 99%, when reacted together form a high carbon melt flowable polymeric material that can apparently couple together and also impregnate the heat processed biomass flour.

Reacting of the thermally modified biomass flour with the monolignol biopolymer can be done at a wide range of ratios, which affect the final performance of the melt flowable biocarbon. At levels of thermally modified biomass from 1% to 50% to the monolignol biopolymer, the material has a viscosity sufficient for injection molding or certain types of extrusion processing with flow characteristics similar to that of a common thermoplastic. This can be used without the addition of a petrochemical thermoplastic, thus resulting in a 100% biobased reinforced bioplastic.

At higher levels of thermally modified biomass, the viscosity increases to the point where profile extrusion and compression molding can be accomplished. Typically levels of approximately 50% still provide for melt flowable and moldable properties, It is within the scope of this invention for higher percentage of thermal modified biomass flour loadings especially based on the further addition of additives such as lubricants, plasticizers and other functional additives.

The MFBC (Melt Flowable Biocarbon) can be pelleted and compounded with various other plastics to impart improvements in performance and its biobased content that can be used by itself to create 100% biobased biocarbon plastics or blended with various other polymers and plastics to improve performance, maintain flow characteristics and lower cost of petroleum plastics Its ability to have a melt flow able property that can be adjusted to match various processes and match various common plastics allows for the ability to load at a wider loading ratio range without negatively effecting the flow characteristics of plastics.

The present invention relates to a use of renewable carbon. Preferably, one part of the biocarbon is produced from plant biomass. The melt flowable biocarbon comprises reacting two primary biobased materials: monolignol biopolymer and powdered biochar or monolignol biopolymer and powdered heat processed wood flour.

### Embodiments

The present invention chemically reacts Monolignol Biopolymer with a thermally process or thermally modified finely divided biomass flour that allows for adjustable melt flows and ability to run at various common plastic processing temperatures.

In one embodiment, the thermally processed or thermally modified flour can be in the form of dried wood flour, thermally modified wood flour, torrefaction processed powder, or biochar powder all derived from biomass sources of wood or agricultural residues.

In another embodiment, a Meltable Lignin Extract from a hybrid organosolv/reactive phase separation cellulosic ethanol reacted with self generated biochemicals process is further reacted and devolatilized to create a stable melt flowable monolignol biopolymer.

The Biochar can be produced at temperatures ranging from about 400° C. up to about 900° C. Temperatures ranging from 450° C. to around 700° C. in a low oxygen environment. This can produce materials with a high degree of chemical functionalization.

In another embodiment, the monolignol biopolymer has a unique dynamic rheology, anti microbial properties, antioxidant functionality, higher aliphatic OH group levels, and other positive functional values.

In one embodiment, the MFBC reacted material includes from 1% to 70% of the thermally processed or thermally modified biomass flour and about 30% to 99% of the carbon rich monolignol biopolymer.

In another embodiment the thermally modified biomass is biochar with an elemental carbon portion greater than 70%

In another embodiment that biochar is produced using pyrolysis of various biomass from temperatures ranging from 150° C. to 900° C. in an low oxygen environment.

In further embodiments the biomass comprises thermally processed and ground wood flour, agricultural biomass, ethanol byproducts, nut shells or hulls, seed hulls, other forms of biomass or blends thereof in which the biomass is thermally processed and ground into a flour.

In further embodiment, the biomass flour has a mesh size ranging from 30 mesh to 500 mesh.

In one embodiment of this invention the monolignol biopolymer is derived from biomass such as that described in U.S. Pat. No. 9,365,525 (System and method for extraction of chemicals from lignocellulosic materials) and U.S. Pat. No. 9,382,283 (Oxygen assisted organosolv process, system and method for delignification of lignocellulosic materials and lignin recovery) herein incorporated by reference in its entirety

In another embodiment the monolignol biopolymer is further processed in accordance with US Provisional Patent (Winsness/Riebel and Monolignol Biopolymer Riebel)

In another embodiment both the elemental carbon biochar and carbon rich monolignol biopolymer are in fine granular or powder form that can be blended to form the Melt Flowable BioCarbon material.

In another embodiment the monolignol biopolymer is created from melt flowable lignin which is further purified to remove sugars/carbohydrates and impurities that allow for a higher melting point and reduced stickiness of the biopolymer.

In further embodiments the. blend of monolignol biopolymer and thermally processed biomass flour which is melt mixed to react into a polymeric material which can be used at is or be further melt blended with a carrier resin.

In one embodiment of the MFBC batch of the present invention, the carrier resin is a synthetic polymer. in one embodiment of the master batch of the present invention, the synthetic polymer is selected from polyethylene (PE), crosslinked-polyethylene (PEX), polypropylene (PP), impact polypropylene, and polybutylene (PB); polyvinylchloride (PVC), chlorinated polyvinyl chloride (CPVC), polyvinylidene fluoride (PVDF), polystyrene (PS), acrylic polymers, nylon, acrylonitrile butadiene styrene, thermoplastic polyurethanes, polycarbonates, or combinations thereof.

In one embodiment of the master batch of the present invention, the carrier resin is a bioplastic.

In one embodiment of the master batch of the present invention, the bioplastic is selected from poly(lactic acid) (PLA), polyglycolic acid (PGA), poly lactic acid-co-glycolic acid (PLGA), polycaprolactone, polyhydroxyalkanoates or combinations thereof.

Additional carrier resins can include but not limited to various polyols, oils, plasticizers, waxes, or blends thereof.

In another embodiment that MFBC can be added to the thermoplastic carrier resin in a range of 1% to 99% given its plastic melt flowable properties.

Another aspect of the invention is melt mixing the melt flowable biocarbon with an olefin plastic in sufficient levels wherein the resulting material is a replacement for PVC.

The invention first uses a novel meltable lignin extract which is a unique biopolymer derived from meltable lignin as described in U.S. Pat. No. 9,365,525 (System and method for extraction of chemicals from lignocellulosic materials) and U.S. Pat. No. 9,382,283 (Oxygen assisted organosolv process, system and method for delignification of lignocellulose and lignin recovery), herein incorporated by reference in its entirety. Meltable lignin extract that is produced using a hybrid organosolv/reactive phase separation process that reacts lignin with self generated biochemicals within the hybrid organosolv process and reacted within the phase separation process to first create the meltable lignin material.

The meltable lignin extract can be modified into a melt flowable lignin biopolymer by further processing and/or with the addition of various chemical additives as described in US Patent Pending (Winsness/Riebel) herein incorporated by reference in it entirety.

The meltable lignin extract then requires an additional process step prior to reacting and melt mixing with various biomass flours. The meltable lignin extract is first processed through a twin screw extruder at temperatures between 300 to 400 degrees F. in which various volatiles are vented and the meltable lignin extract changes. The melt temperature of the extract increases from 180 degrees F. to 300 degrees F. which is now within a normal plastic processing temperature, but still has good flow characteristics. The monolignol biopolymer in this state is a hard solid at room temperature and has unique properties including, but not limited to high degree of water resistance, higher in aliphatic OH groups, polar, integrates antimicrobial and antioxidant functionality, improved compatibility with other polymers and reduced odor. The MLB also has a high carbon content typically over 70%.

The monolignol biopolymer (MLB) can be in the form of a powder, flour, regrind particles or pellets. The MLB material is then reacted through high heat compounding using a twin screw extruder with various forms of thermally processed biomass flour or powder.

Thermally Processed and Thermally Modified Biomass

The invention further reacted and compounds a finely divided thermally processed biomass with the MLB material. Thermally processed biomass may be produced from one or more biomass sources like energy crops, such as miscanthus and switchgrass, other planiltree fibers, agricultural/forest biomass, municipal solid waste (MSW), and/or animal/bird manures, and other coproducts and waste streams of agricultural products including but not limited to dried distillers grains, coffee chaff, spent tea leaves, spent coffee grinds, etc. Different sources of biocarbon produced by plants may present different chemical and physical properties such as ash content, carbon content, morphology, surface chemistry, etc. Also such different sources can produce different effects on the final properties of the composite or material,

Thermal processing of the biomass subjects the biomass to various beat profiles and ground into a fine flour typically ranging from 30-500 mesh and more preferably between 100-300. Thermal processing has the ability to change the biomass flour into various forms including wood flour, thermally modified wood flour, terrified wood flour, and biochar flour. Thermal processing or modification does remove moisture content of the biomass to levels below 10% and more preferably moisture contents below 5%. In addition this has the ability to remove various volatiles from the biomass and changes its basic chemical structure, removing hemicellulose and other components. so that it reacts with the monolignol biopolymer at various levels.

Thermally Processed Wood Flour

The production of wood flour is known wherein wood chips or particles are dried at high heats. This not only removes the moisture, but can remove a percentage of volatiles within the wood. After the heating process, the wood is ground and screened using standard grinding systems to mesh sizes commonly between 30-400 mesh. Currently most wood flour is used as a simple filler in various compression molding applications such as toilet seats and wood plastic composites. Wood flour such as is available through Marth Corporation in Wisconsin can be used within this invention. In this form the wood flour is below 5% and has a carbon content of approximately 50%,

Torrefaction Processed Biomass

Torrefied wood is a process wherein wood is thermally processed in al ow oxygen environment. Torrefaction of biomass, e.g., wood or grain, is a mild form of pyrolysis at temperatures typically between 200 and 320° C. Torrefaction changes biomass properties. Torrefaction produces a dry product with no biological activity like rotting in addition removal of various volatiles and reduction in hemicellulose. The torrefied wood is then ground into a fine flour for this invention.

Pyrolyzed Biomass—BIOCHAR

Pyrolysis is the thermal decomposition of materials at elevated temperatures in an inert atmosphere. It involves a change of chemical composition and is irreversible.

Biochar is the solid product remaining after biomass is heated to temperatures typically between 300° C. and 700° C. under oxygen-deprived conditions, a process known as “pyrolysis. In contrast to the original biomass feedstock that mainly contains cellulose, hemicellulose, and lignin, biochar falls into the spectrum of materials called “charcoal” or “black carbon” or “elemental carbon biochar” or “biocarbon”. Biochar has a high degree of carbon content typically ranging from 70% to 99% based on processing parameters.

The pH of the biocarbon biochar element is important. Various pyrolysis temperatures have a significant effect on the final pH of the biochar. At temperature around 300 C to 400 C can yield a pH of 6-7 with most wood biomass. As temperatures increase to over 700 C to 900 C we see a significant rise in pH around 9-10.

The pH, porosity and biomass source for the biochar has various effects on the final MFBC material. The monolignol biopolymer typically has a low pH between 3-5 wherein the biochar typically has a higher pH based on its processing temperature. When melt reacting these two material together we see a significant change in performance, reduced odor, ability to neutralize the pH and improved compatibility with other polymeric materials.

The inventors believe that the higher pH of the biocarbon char and its porous nature that can absorb various gasses and volatiles, neutralizes and chemically reacts with the acidic monolignol biopolymer during melt phase compounding to provide a wide range of advantages while producing a melt flowable product. The melt flowable biocarbon melt viscosity can be adjusted to meet specific thermoplastic melt flow indexes for improved processing.

Within this invention the elemental carbon biochar can be produced by various means. Standard biochar processing uses large heating chambers with high heat and limited oxygen wherein the heat is supplied by a secondary fuel source.

This invention also includes other forms of processing biochar including that of using 100% kinetic energy to heat the biomass as to create the biochar, The invention also including various forms of biochar or biochar like materials such as torrified wood, pyrolysis biomass, charcoal and activated charcoal.

Biochar from biomass resources is different than carbon black commonly used in plastics. By demonstrating that Monolignol Biopolymer made with blended biochar have equal or better material properties than those made with just carbon black we have seen a substantial different in overall physical and mechanical performance when reacted with monolignol biopolymers, our surprise we seen other differences which provided significantly improved strength, reduced odor, and improved compatibility with other polymers or thermoplastics.

Reacting MLB with Thermally Processed Biomass Flour

The monolignol biopolymer can be in the form of fine granular or a powder, The biochar also can be ground into a fine powder using standard method of grinding known to those skilled in the art, The two materials are dry blended at specific ratios based on the final application.

Using either a high shear single screw, twin screw compounder or other processes of melt mixing the two materials are reacted together under heat and pressure to form a melt flowable material. The material can then be easily pelletized within this process to create the melt flowable biocarbon pellet. Pellets are typically similar in size to most common thermoplastic pellets.

To our surprise the reaction provides for a significant increase in strength of the final material well beyond that of the monolignol biopolymer in addition to a significant decrease in odor. In addition this also provides for a different reactively which allows for the blending with a wider range of thermoplastics, bioplastics or polymers than each of the material individually.

In addition through experimentation we find that the monolignol biopolymer has the ability to substantially fully impregnate thermally processed biomass as to create very high levels of moisture resistance and complete waterproof materials.

The melt flowable biocarbon can also include a wide range of additives including but not limited to: fiber reinforcement, plasticizers, processing aids. colorants, oils, waxes, lubricants and other common additives used in thermoplastic processing.

The melt flowable biocarbon comprising the monolignol biopolymer and the thermally processed biomass can be in the form of a ground flour, regrind particle or pellet which can be further processed by itself into various composite products or be further blended with thermoplastics and bioplastics to broaden it commercial application.

Plastics

The Melt Flowable BioCarbon of this invention (MFBC) can be further melt processed with various common thermoplastics or bioplastics wherein the MFBC in a pellet form can be simply blended with various plastics within the extrusion, injection molding or compression molding processes commonly used for plastic processing.

The MFBC blend of the present invention, the carrier resin is a synthetic polymer, in one embodiment of the master batch of the present invention, the synthetic polymer is selected from polyethylene (PE), crosslinked-polyethylene (PEX), polypropylene (PP), impact polypropylene, and polybutylene (PB); polyvinylchloride (PVC), chlorinated polyvinyl chloride (CPUC), polyvinylidene fluoride (PVDF), polystyrene (PS), acrylic polymers, nylon, acrylonitrile butadiene styrene, thermoplastic polyurethanes, polycarbonates, or combinations thereof.

Bioplastics also can be melt blended. Bioplastic is selected from poly(lactic acid) (PLA), polyglycolic acid (PGA), poly(lactic acid-co-glycolic acid (PLGA), polycaprolactone, polyhydroxyalkanoates or combinations thereof.

The addition levels of MFBC to various plastics can range from 1% to 50% or hit her based on the final application.

Compatiblity

Lignin in general and monolignol biopolymer are highly polar materials. Monolignol biopolymers have very high levels of aliphatic OH groups. Thus blending with various “non polar” plastics such as olefins is challenging.

De-polymerization also improved the compatibility of the lignins with the nonpolar polymer matrix by decreasing the aliphatic hydroxyl content and improving the hydrophobicity. Open-chain compounds (whether straight or branched) contain no rings of any type, and are thus aliphatic.

In various applications wherein the melt flowable biocarbon is blended with a non polar plastic such as HDPE, PP and other non polar plastics, a compatibilizer is included within this invention. Compatibilizers or compatibilizers with plasticizers are also included. Various compatibilizers or compatibilizing plasticizers include, but not limited to: citric acid, acetic acid, maleic anhydride, various acids, surfactants, glycerin, glycols, polyols, acrylates and blends there of.

Compatibilizers can be coupling agents. Coupling agent include, but not limited to silane, an organic acid, a di-acid, a tri-acid, an anhydride, a cyclic anhydride, boric acid, a maleic anhydride grafted polyolefins, succinic acid, succinic anhydride, glutaric acid, glycolic acid, oxalic acid, citric acid, or adipic acid.

Citric acid seems to cross link and increases compatibility of the melt flowable biocarbon when melt mixed with various non polar plastics. The inventors believe that the citric acid forms strong hydrogen bonds with the monolignol biopolymer to improve overall performance and provide improved compatibility with various non polar plastics such as various polyolefins.

The melt flowable biocarbon also provides for:

(a) Antimicrobial Functionality—The melt flowable biocarbon can impart various functional features including antimicrobial functionality within various plastics or polymers. The antimicrobial properties of lignin have been attributed to the nature of phenolic compounds. The polyphenol compounds of lignin are known to damage the cell membranes of microorganism and to cause lysis of the bacteria

(b) Antioxidant Functionality—One of the challenges of working with polymers is their degradability when used in high-temperature conditions or in outdoor applications, which can result in the breaking of polymer chains, the production of free radicals and the subsequent reduction in molecular weight, thereby deteriorating mechanical properties and rendering materials useless for their end use purposes. Therefore, almost all synthetic polymers require stabilization against adverse environmental effects.

Antioxidants being exploited are the additives for retarding oxidation or bio- or photo-degradation of polymer blends. The monolignol biopolymer derived from lignin through the hybrid organosolv/reactive phase separation process provides for “ring opening polymerization” and de-polymerization. The de-polymerized monolignols have up to five times more antioxidant activity compared to the crude lignins, a result of their higher phenolic content, improved hydrophobicity, and lower molecular weight.

Polyethene and polypropylene all require antioxidants for exterior uses especially when trying to replace PVC.

(c) UV resistance—Lignin and monolignol biopolymers derived from modified lignin are the only biomass rich in aromatic; rings in nature due to its basic phenylpropane unit. It also contains UV-absorbing functional groups such as phenolic, ketone and other chromophores. Lignin is a natural broad-spectrum sun blocker. In addition to the sunscreen property, the free radical scavenging ability of phenolic groups gives lignin an excellent antioxidant property.

(d) Performance—Mechanical strength is significantly improved when reacting the monolignol biopolymer with biocarbon in biochar. To our surprise, the inventors found that addition rates of 10-30% of biochar reacted with the monolignol biopolymer significantly improves the overall mechanical strength of the monolignol material.

Methods of Manufacturing

Process I—Meltable Lignin Extract to MLB

The carbon rich meltable lignin extract was obtained from Attis Innovations in a granular form derived as a co-product of cellulosic ethanol production using hybrid organosolv/reactive phase separation processing.

The material is ground into a fine granular or powder consistency. In one method the material can be further washed with water and to remove residual carbohydrates and other impurities but not required for this invention, The impurities are water soluble wherein the monolignol biopolymer is highly hydrophobic.

A second option process is where the meltable lignin extract then is processed at high heat (approximately 400 degrees F.) using a vented extruder which further reacts the meltable lignin extract by removing volatiles and reduces the carbohydrates/sugar portion of the meltable lignin extract. This process greatly increases the melting point and viscosity sufficiently to be within normal plastic processing parameters. The processes of this patent can include both washing and high temperature reacting/devolatlization process or these separately.

The output from the vented extruder can be either formed into pellets or simply reground into various size particles or finely divided material such as flour or powder forms.

Process II—Thermally Processed or Modified Wood Flour

Wood is dried to a low moisture content using high heat and ground into a fine flour between 30-500 mesh. Given the temperature of processing various levels of hemicellulose are changed and volatiles are removed.

Process Torrefaction Wood Flour

Wood chips, sawdust or particles of biomass are placed into a rotary kiln or moving bed reactor and heated, in a low oxygen environment. Typical processing temperatures range from 200 to 320 C degrees. With this process hemicellulose is further degraded and higher amounts of volatiles are removed. The torrefaction particles are then ground into a fine powder between 30-500 mesh

Process IV—BioChar—Thermally Pyrolyzed Wood Flour

Wood is placed into a heating vessel and heated subjected to a low oxygen environment at sufficiently high temperatures to “char” the material changing its chemical composition irreversibly. This degrades and removes hemicellulose, lignin, and volatiles within the wood leaving a charcoal type material called biochar. The biochar is then ground into a fine powder ranging from 100-700 mesh.

Process V—MLB with Thermally Processed Wood Flours

The monolignol biopolymer can be blended with wood flour, thermally modified wood flour, torrefaction wood flour, or biochar in ranges from 1% to 60% and more preferably between 20% to 50% with simple dry blending. The admixture is then fed into a. twin screw compounding system and heat reacted. Processing temperature can range from 300 to 400 degrees F. based on the loadings of thermally modified biomass. The resultant material can be pelletized, ground into particles or ground into a flour form.

Process VII—Forming of MFBC

The melt flowable biocarbon can then be processed using various plastic processing equipment such as profile extrusion, sheet extrusion, injection molding, compression molding, sheet processing, film extrusion and other traditional plastic processing methods to create various 100% biobased carbon products.

Process—Post Processing Components

Although not required, a formed MFBC component can be placed under additional heat conditions to further “thermoset” the composite

Process—MFBC with thermoplastics and BioPlastics—The melt flowable mono-lignol biopolymer that has been already reacted with the thermally modified biomass can further be melt blended with various thermoplastics or bioplastics to impart various functional characteristics and lower cost. Typical additions with thermoplastics and bioplastics range from 1% to over 50%.

Process—MFBC with Plasticizers

The process can also include the integration of various plasticizers. Various plasticizers can be, but not limited to, polyols, oils, waxes, and other common plastic plasticizers to improve impact resistance and soften the material to the point of becoming an elastomer.

Process MFBC with Thermoset (Isocyanates)

The process can also include the addition of various thermosetting material such as phenol resins, isocyanates and polyesters to form a more thermally stable end product.

Process X—Liquor

A second method for production the melt flowable biocarbon is wherein the powdered biochar is blended within the liquid phase of the monolignol biopolymer during processing wherein the monolignol biopolymer still contains self generated biosolvents from this process and can be in a viscosity range from water to a thick tar. This also provides potential for improved reaction and dispersion of the powdered biochar within the monolignol material.

Melt Flowable BloCarbon Material Performance

MFBC has various technical, performance and environmental advantages.

Significantly higher mechanical strength

Improved thermal stability

Antioxidant Properties

High Carbon Content

High in aliphatic OH groups and highly reactive

Antimicrobial properties

Ability to match melt flow viscosities of various common plastics

Reduced or zero odor

Improved compatibility with various bioplastics and petroleum based plastics.

UV resistant and UV absorption advantage

Ability to carbonize into various unique carbon structures

Lower cost than petrochemical plastics

Ability to blend at extruder or injection molder that may eliminate costly pre compounding

100% biobased

Compatible with other polymers, polyols, plasticizers, etc.

Post Processing

In post processing the melt flowable biocarbon can use various processes to create shapes, components or products using various plastic processing equipment including, but not limited to injection molding, profile extrusion, sheet extrusion, compression molding, continuous sheet compression molding, rotary molding, film extrusion and other similar process used in plastics.

EXPERIMENTS

Experiment I

A organosolv meltable lignin extract as produced by U.S. Pat. No. 9,365,525 which is a solid “black glass” looking material at room temperature was evaluated for melt point and viscosity by placing a piece on an aluminum sheet and placed in an oven in which the temperature was slowly ramped to 300 degrees F. At slightly less than 180 F the material started to melt, the material was very low viscosity and flowed out to a thin layer on the sheet. After cooling, the material stuck to the aluminum and left a stain when forced off the sheet. The kii,14 material had a strong negative odor before and after this experiment. In addition the material was very brittle and easily broke by hand showing little strength characteristics.

Experiment II

Monolignol Biopolymer

The meltable lignin extract from experiment one was ground into a fire powder then water was added to wash the material using hot water. The material phase separated into various layer in which the MLB layer was at the bottom and sugar/carbohydrate layer was on the top. The bottom layer was then dried and remained as a powder material. The material was placed on an aluminum plate and ran through the same heat ramp as Exp I. The material had significantly higher melting point, less stickiness and not stain on the aluminum although the material. The material had less odor, but still remained and the final material also was very brittle with little to no strength. An addition test was ran wherein the water was replaced with ethanol which also provided purification, reduction in odor and other advantages.

Experiment II

Vented Extrusion Reactions—Biopolymer

The meltable lignin extract from Experiment 1 was placed into a twin screw vented extruder and processed at temperatures between 350 to 420 degrees F., The material release significant volatiles and reduced the sugar carbohydrate levels as seen in HPLC data. The resulting polymeric material had a much higher melting point of around 300 degrees F. and an improved viscosity more closely representing a thermoplastic. In addition the material had less odor and reduced stickiness to the metal.

Experiment IV—MLB with Thermally Processed Wood Flour

The monolignol biopolymer from above experiment was then blended with 30% wood flour and processed at 180 degrees C. through a vented twin screw extruder. To our surprise, the material bad very good flow characteristics. The material was then analyzed which showed that the monolignol biopolymer which is black in color had impregnated the thermally processed fine wood flour particles. The sample had very high water resistance to water proof properties.

Using a fine wood flour between 100-200 mesh, various ratios of wood flour were compounded using a twin screw extruder with the monolignol biopolymer. At levels of wood flour around 30% we have seen a change in the material. While still flowable, the material had significantly higher strength In addition we have seen that the wood flour was substantially fully impregnated with the MLB material making it very hydrophobic and in some samples fully water proof. A second blend was compounding in the twin screw using wood flour and a thermoplastic (HDPE) at the same levels. From this test we seen that the wood flour was encapsulated, but not impregnated, thus once the sample was sanded, it exposed the wood flour which soaked up water.

Experiment

A Monolignol Biopolymer with Carbon Black

The same MLB from experiment f in powder form was mixed with carbon black at 25% at a carbon black percentage of 10% and melt mixed at a temperature between 275 to 300E. After cooling, the material only had slight improvement of performance and was easily broken. The piece did have a reduced odor but still bad a negative smell.

Experiment IV

MLB with BioChar

Monolignol biopolymer from experiment I in powder form was mixed with a wood based powder biochar processed at a temperature over 700 C at levels of 10%, 25% and 50% loadings with the MLB material. The materials were melt mixed at a temperature between 275 to 300 F. The material was then cooled overnight. The next day to our surprise the material had no odor and to our surprise was extremely strong in which a ⅜″ sample thickness could not be broken by hand being significantly improved over carbon black. The normal MLB material and carbon black MLB material is very brittle with no strength, thus easy to break by hand at a similar thickness.

The material was then granulated into particles and ran through a melt single screw extruder. The material did not show signs of stickiness and created good strands for pelletizing.

Experiment V

Monolignol Liquid Biopolymer with Biochar

A form of liquid lignin extract from U.S. Pat. No. 9,365,525 was obtained from Attis Innovations in which the MLB was still in its liquid form of 90% self generated biosolvents and 10% solids MLB. The powdered biochar was added to the liquid wherein the biochar represented 25% of the MLB solids within the liquid. The liquid was heated and mixed sufficiently to disperse the materials The liquid was then placed in an oven to remove the biosolvents. The remaining solid was similar to that of Exp IV wherein the odor was not detectable and the piece showed high degrees of strength.

Experiment VI

Monolignol Biopolymer with Biochar and Plastic

In comparing the raw MLB material to the Melt flowable biocarbon, we first blended MLB with a HDPE both in granular form which was then ran through an extruder at a temperature of 160 C. The material had poor compatibility and did not mix creating “chunks” of materials coming though the extruder. In addition we seen phase separation, stickiness and significant odor from this process.

The Melt Flowable BioCarbon comprising both monolignol biopolymer and biochar blend wherein biochar content was 20% was then also mixed with HDPE and extruded as above. This blend ran very differently with low VOC's, greatly reduced odor and improved dispersion.

Experiment VI1

Meltflowable Biopolymer with Bioplastic

A blend of monolignol biopolymer reacted with 25% of thermally modified wood flour was first reacted and produced into a pellet The pellets of the MFBP was then blended with PBAT bioplastic pellets and compounded, The material was flexible and tough similar to that of a flexible PVC type material.

Experiment VIII

Monoligno/Biopolymer with Thermally Modified Biomass Flour and Polyol

The MLB/BioChar mixed blend from Exp IV was melt mixed with a polyol commonly used in polyurethane applications (Emerox). The material was heated to 250 F and mixed until a homogenous mixture was achieved. The material was allowed to cool resulting in an elastomeric taffy like material. In further experiments we were able to adjust the level of biochar to control the elastic nature and toughness of the final material.

Experiment IX

MLB with Biomass Flour and Thermoset Resin (isocyanate)—In Process

The specific examples below are to be construed as merely illustrative, and not limitative of the remainder of the invention in any way whatsoever. Without further elaboration, it is believed that one skilled in the art can, based on the description presented herein, utilize the present invention to the full extent. Any mechanism proposed below does not in any way restrict the scope of the claimed invention, Thus the scope of the invention should be determined by the appended claims and their legal equivalents, rather than by the examples given.

### CONCLUSION

Various modifications and variations can be made in the present invention without departing from the spirit or scope of the invention.

From the foregoing, it will be seen that this invention is one well adapted to obtain all the ends and objects herein set forth, together with other advantages which are obvious and which are inherent to the structure.

It will be understood that certain features and sub combinations are of utility and may be employed without reference to other features and sub combinations. This is contemplated by and is within the scope of the claims.

As many possible embodiments may be made of the invention without departing from the scope thereof, it is to be understood that all matter herein set forth or shown in the accompanying drawings is to be interpreted as illustrative and not in a limiting sense.

1. A melt flowable biocarbon polymer comprising a blend of a melt flowable monolignol biopolymer and a thermally processed biomass flour.

2. A melt flowable biocarbon of claim 1 wherein the melt flowable monolignol biopolymer is derived from a hybrid organosolv/reactive phase separation cellulosic biofuel process by further devolatilizing and reacting a meltable lignin extract.

3. A melt flowable biocarbon of claim 2 wherein the thermally processed biomass is derived from trees, wood, wood waste, agricultural residues, nut or seed hulls or blends thereof.

4. A melt flowable biocarbon of claim 3 wherein thermal processed biomass can be dried wood flour, thermally modified wood flour, torrefied wood flour, pyrolyzed wood flour, biochar or blends thereof.

5. A melt flowable biocarbon of claim 1 wherein thermally processed biomass flour has a mesh size between 30 to 500 mesh.

6. A melt flowable biocarbon of claim 1 wherein thermally modified biomass flour comprises 1-60% of the melt flowable biocarbon.

7. A melt flowable biocarbon of claim 1 wherein the melt flowable biocarbon has a melt flow similar to thermoplastics, antioxidant and antimicrobial functionality and highly hydrophobic.

8. A melt flowable biocarbon of claim 1 wherein the thermally processed biomass flour is substantially fully impregnated by the monolignol biopolymer.

9. A melt flowable biocarbon of claim 1 wherein the melt flowable biocarbon comprising a heat reacted blend of monolignol biopolymer and thermally processed biomass in the form of a powder, granular, pellet, shaped extrusion, injection molded shape, compression molded shape or sheet.

10. A melt flowable biocarbon of claim 1 wherein it further comprises a thermoplastic, bioplastics or thermoset polymer.

11. A melt flowable biocarbon of claim 9 wherein the thermoplastic is selected from polyethylene (PE), crosslinked-polyethylene (PEX), polypropylene (PP), impact polypropylene, and polybutylene (PB); polyvinylchloride (PVC), chlorinated polyvinyl chloride (CPVC), polyvinylidene fluoride (PVDF), polystyrene (PS), acrylic polymers, nylon, acrylonitrile butadiene styrene, thermoplastic polyurethanes, polycarbonates, ABS, Metalocene, EVA or combinations thereof.

12. A melt flowable biocarbon of claim 9 wherein the bioplastics is selected from poly(lactic acid) (PLA), polyglycolic acid (PGA), poly(lactic acid-co-glycolic acid (PLGA), polycaprolactone, polyhydroxyalkanoates, PBAT or combinations thereof

13. A melt flowable biocarbon of claim 1 further comprising a functional additive: polyol, plasticizer, oil, wax, lubricant, colorant, mineral, epoxified oil, isocyanate, polyester resin, acid couplers, etc.

14. A melt flowable biocarbon of claim 1 wherein the addition level of thermally processed biomass ranges from 0.5% to 60%.

15. A melt flowable biocarbon of claim 1 wherein the carbon content is greater than 50%.
